(19) United States
(12) Patent Application Publication
(10) Pub. No.: US 2026/0075375 A1
(43) Pub. Date: Mar. 12, 2026

(54) MULTI-STREAM PROCESSING OF SINGLE-STREAM DATA

(71) Applicant: QUALCOMM Incorporated, San Diego, CA (US)

(72) Inventors: Shuhua ZHANG, San Diego, CA (US); Siddhartha Goutham SWAMINATHAN, San Diego, CA (US); Jason FILOS, San Diego, CA (US); Van NGUYEN, San Diego, CA (US); Erik VISSER, San Diego, CA (US)

(21) Appl. No.: 19/108,402

(22) PCT Filed: Oct. 25, 2023
(86) PCT No.: PCT/US2023/077782

§ 371 Date: Mar. 3, 2025

(30) Foreign Application Priority Data
Oct. 31, 2022 (GR) 20220100876

(51) Int. Cl. H04S 7/00; G06N 3/044; G06N 3/08

(52) U.S. Cl. CPC H04S 7/30; G06N 3/044; G06N 3/08; H04S 2400/03

(57) ABSTRACT

A device includes one or more processors configured to detect single-stream data and generate multi-stream augmented data that includes one or more modified versions of the single-stream data. The one or more processors are configured to process the multi-stream augmented data to generate multiple output channels. The one or more processors are also configured to reduce the multiple output channels to produce single-stream output data.

### I. CROSS-REFERENCE TO RELATED APPLICATIONS

The present application claims the benefit of priority from the commonly owned Greece Provisional Patent Application No. 20220100876, filed Oct. 31, 2022, the contents of which are expressly incorporated herein by reference in their entirety.

### II. FIELD

The present disclosure is generally related to processing a stream of data.

### III. DESCRIPTION OF RELATED ART

Advances in technology have resulted in smaller and more powerful computing devices as well as an increase in the availability of and consumption of media. For example, there currently exist a variety of portable personal computing devices, including wireless telephones such as mobile and smart phones, tablets and laptop computers that are small, lightweight, and easily carried by users and that enable generation of media content and consumption of media content nearly anywhere.

Advances in signal processing have resulted in improvements in applications that use input signals, such as voice call applications that can provide audio voice enhancement and noise reduction for an input voice signal. In particular, signal processing using neural networks can provide enhanced performance as compared to conventional techniques. Improving the performance of such neural networks is conventionally achieved by increasing the size of the neural networks, which requires using additional weight coefficients. However, in practice, neural network performance is typically limited by the amount of memory bandwidth available for transferring weight coefficients from memory to computation hardware that is used to execute the neural network. For example, transferring the weight coefficients can require more power than performing the computations that use the weight coefficients. Improving the signal processing performance of a neural network in light of such memory bandwidth and power constraints associated with transfer of the weight coefficients would enhance device performance and user experience, especially for low-power, real-time applications on portable communication devices.

### IV. SUMMARY

According to a particular aspect, a device includes a memory configured to store instructions. The device also includes one or more processors configured to detect single-stream data and to generate multi-stream augmented data that includes one or more modified versions of the single-stream data. The one or more processors are configured to process the multi-stream augmented data to generate multiple output channels. The one or more processors are further configured to reduce the multiple output channels to produce single-stream output data.

According to a particular aspect, a method includes detecting, at one or more processors, single-stream data. The method includes generating multi-stream augmented data including one or more modified versions of the single-stream data. The method includes processing the multi-stream augmented data to generate multiple output channels. The method also includes reducing the multiple output channels to produce single-stream output data.

According to a particular aspect, a non-transitory computer-readable medium stores instructions that, when executed by one or more processors, cause the one or more processors to detect single-stream data. The instructions, when executed by the one or more processors, cause the one or more processors to generate multi-stream augmented data including one or more modified versions of the single-stream data. The instructions, when executed by the one or more processors, cause the one or more processors to process the multi-stream augmented data to generate multiple output channels. The instructions, when executed by the one or more processors, further cause the one or more processors to reduce the multiple output channels to produce single-stream output data.

According to a particular aspect, an apparatus includes means for generating multi-stream augmented data including one or more modified versions of single-stream data. The apparatus includes means for processing the multi-stream augmented data to generate multiple output channels. The apparatus also includes means for reducing the multiple output channels to produce single-stream output data.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system operable to perform multi-stream processing of single-stream data, in accordance with some examples of the present disclosure.

FIG. 2 is a diagram of particular aspects of the system of FIG. 1, in accordance with some examples of the present disclosure.

FIG. 3 is a diagram of particular aspects of the system of FIG. 1, in accordance with some examples of the present disclosure.

FIG. 4 is a diagram of particular aspects of the system of FIG. 1, in accordance with some examples of the present disclosure.

FIG. 5 is a diagram of particular aspects of the system of FIG. 1, in accordance with some examples of the present disclosure.

FIG. 6 is a diagram of particular aspects of the system of FIG. 1, in accordance with some examples of the present disclosure.

FIG. 7 is a diagram of particular aspects of the system of FIG. 1, in accordance with some examples of the present disclosure.

FIG. 8 is a diagram of particular aspects of the system of FIG. 1, in accordance with some examples of the present disclosure.

FIG. 9 is a diagram of particular aspects of the system of FIG. 1, in accordance with some examples of the present disclosure.

FIG. 10 is a diagram of particular aspects of the system of FIG. 1, in accordance with some examples of the present disclosure.

FIG. 11 is a diagram of particular aspects of the system of FIG. 1, in accordance with some examples of the present disclosure.

FIG. 12 is a diagram of particular aspects of the system of FIG. 1, in accordance with some examples of the present disclosure.

FIG. 13 is a diagram illustrating particular aspects of operations performed by the system of FIG. 1, in accordance with some examples of the present disclosure.

FIG. 14 illustrates an example of an integrated circuit operable to perform multi-stream processing of single-stream data, in accordance with some examples of the present disclosure.

FIG. 15 is a diagram of a mobile device operable to perform multi-stream processing of single-stream data, in accordance with some examples of the present disclosure.

FIG. 16 is a diagram of a headset operable to perform multi-stream processing of single-stream data, in accordance with some examples of the present disclosure.

FIG. 17 is a diagram of a wearable electronic device operable to perform multi-stream processing of single-stream data, in accordance with some examples of the present disclosure.

FIG. 18 is a diagram of a voice-controlled speaker system operable to perform multi-stream processing of single-stream data, in accordance with some examples of the present disclosure.

FIG. 19 is a diagram of a camera operable to perform multi-stream processing of single-stream data, in accordance with some examples of the present disclosure.

FIG. 20 is a diagram of a headset, such as a virtual reality, mixed reality, or augmented reality headset, operable to perform multi-stream processing of single-stream data, in accordance with some examples of the present disclosure.

FIG. 21 is a diagram of a first example of a vehicle operable to perform multi-stream processing of single-stream data, in accordance with some examples of the present disclosure.

FIG. 22 is a diagram of a second example of a vehicle operable to perform multi-stream processing of single-stream data, in accordance with some examples of the present disclosure.

FIG. 23 is a diagram of a particular implementation of a method of performing multi-stream processing of single-stream data that may be performed by a device of FIG. 1, in accordance with some examples of the present disclosure.

FIG. 24 is a block diagram of a particular illustrative example of a device that is operable to perform multi-stream processing of single-stream data, in accordance with some examples of the present disclosure.

### VI. DETAILED DESCRIPTION

Neural network performance in processing real-time data, such as performing noise reduction in audio data during a voice call, is typically limited by the amount of memory bandwidth available for transferring weight coefficients from memory to computation hardware that is used to execute the neural network. For example, the number of weight coefficients that can be transmitted to the computation hardware for processing frames of incoming audio data can be constrained by the available memory bandwidth and the frame rate of the incoming audio data. In addition, power consumption associated with transmitting the weight coefficients can exceed that of performing the computations associated with the weight coefficients.

Systems and methods of performing multi-stream processing of single-stream data are disclosed. For example, according to a particular aspect, the single-stream data is used to generate multi-stream data using a process referred to herein as multi-stream augmentation. An example of single-stream data is single-channel audio, and multi-stream augmentation of the single-channel audio can result in multiple distinct but related streams of the audio. However, single-stream data is not limited to single-channel audio, and may instead include dual-channel audio, multi-channel audio, or one or more other types of single-channel or multi-channel timeseries data.

According to some aspects, a network, such as a recurrent neural network, processes each of the multiple streams in parallel with each other by performing the same computations (e.g., reusing the same weights) for each of the multiple streams before reducing the multiple resulting processed streams into a single stream for output.

According to some aspects, the multiple streams generated from the single stream via multiple-stream augmentation are equivalent but not identical to each other. To illustrate, the multiple streams may be generated by performing one or more linear operations on the single stream and may be numerically distinct from each other.

Techniques that can be used to generate the multiple streams include attenuation and/or amplification of the single-stream data, time-domain shifting, frequency-domain phase shifting, and frequency-domain group phase shifting, as illustrative, non-limiting examples.

Since the multiple streams are equivalent to each other, they can be processed using the same neural network computations. In addition, since the multiple streams are different from each other, features that may be missed in one stream can be picked up in another stream, producing better output (e.g., improved speech preservation for noise suppression), without increasing the number of weight coefficients as compared to performing single-stream processing. Although processing more streams increases an amount of computation that is performed as compared to processing a single-stream, neural network accelerators typically have a sufficient amount of computing resources to accommodate the additional computation and are instead constrained by memory bandwidth associated with loading the weight coefficients. To illustrate, components such as neural processing units (NPUs) that are specialized for neural network processing can provide dedicated circuitry to enable efficient parallel processing of very large data sets associated with machine learning models.

According to some aspects, the multi-stream augmentation can be performed at run-time (e.g., during an inference operation) and applied to recurrent networks that are trained with only single-stream data. Alternatively, the multi-stream augmentation can be performed both at training-time and at run-time. Performing multi-stream augmentation when training the neural network enables the neural network to learn to process multi-stream augmented data to achieve better results as compared to training the neural network using single-stream training data.

Improving the signal processing performance of a neural network in light of memory bandwidth and power constraints associated with transfer of the weight coefficients enhances device performance and improves user experience, especially for low-power, real-time applications on portable communication devices.

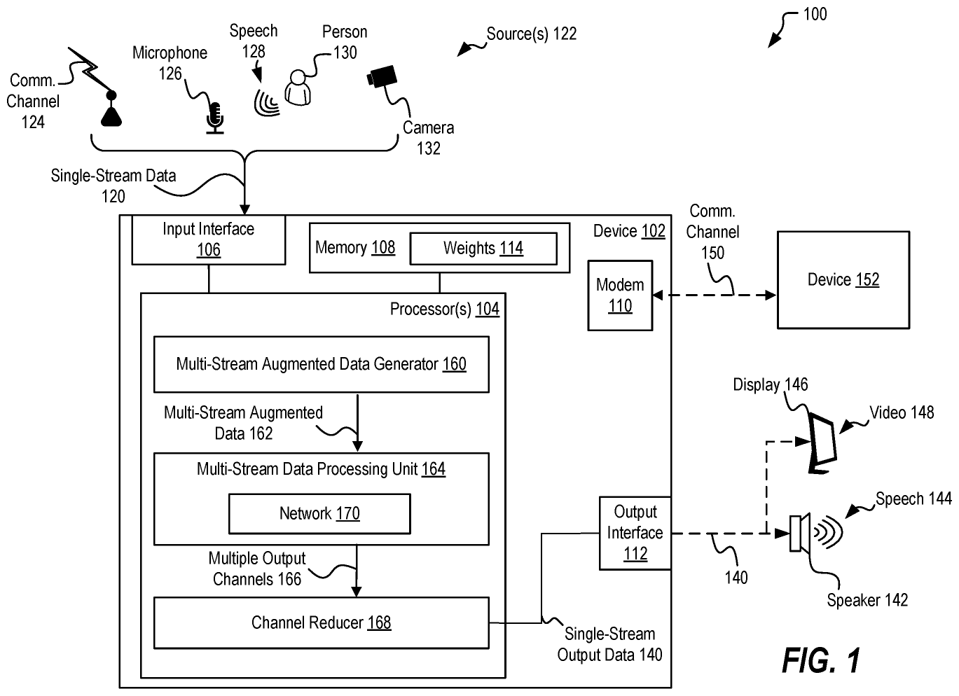

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 104 of FIG. 1), which indicates that in some implementations the device 102 includes a single processor 104 and in other implementations the device 102 includes multiple processors 104. For ease of reference herein, such features are generally introduced as “one or more” features and are subsequently referred to in the singular or optional plural (as indicated by “(s)” in the name of the feature) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations.

Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 configured to perform multi-stream processing of single-stream data is shown. In the example illustrated in FIG. 1, the system 100 is configured to generate single-stream output data 140 based multi-stream processing of single-stream data 120.

The system 100 includes a device 102 that is coupled to or includes one or more sources 122 of media content of the single-stream data 120. For example, the source(s) 122 may include one or more microphones 126, one or more cameras 132, a communication channel 124, or a combination thereof. In the example illustrated in FIG. 1, the source(s) 122 are external to the device 102 and coupled to the device 102 via an input interface 106; however, in other examples, one or more of the source(s) 122 is a component of the device 102. To illustrate, the source(s) 122 may include a media engine (e.g., a game engine or an extended reality engine) of the device 102 that generates the single-stream data 120 based on instructions executed by one or more processors 104 of the device 102.

The single-stream data 120 may include data representing speech 128 of a person 130. For example, when the sources 122 include the microphone(s) 126, the microphone(s) 126 may generate signals based on sound of the speech 128 to provide the single-stream data 120. When the source(s) 122 include the camera(s) 132, the single-stream data 120 may alternatively, or additionally, include one or more images (e.g., video frames) depicting the person 130. When the source(s) 122 include the communication channel 124, the single-stream data 120 may include transmitted data, such as a plurality of data packets encoding the speech 128. The communication channel 124 may include or correspond to a wired connection between two or more devices, a wireless connection between the two or more devices, or both. According to a particular aspect, the single-stream data 120 includes a sequence of data frames of content from the source(s) 122.

In FIG. 1, the device 102 includes an input interface 106, an output interface 112, the processor(s) 104, a memory 108, and a modem 110. The memory 108 is configured to store weight coefficients, illustrated as network weights 114, that are accessible to the processor(s) 104 in conjunction with operation of a network 170 (e.g., a recurrent network), as described further below. The input interface 106 is coupled to the processor(s) 104 and configured to be coupled to one or more of the source(s) 122. In an illustrative example, the input interface 106 is configured to receive microphone output from the microphone(s) 126 and to provide the microphone output to the processor(s) 104 as the single-stream data 120.

The output interface 112 is coupled to the processor(s) 104 and configured to be coupled to one or more output devices, such as one or more speakers 142, one or more display devices 146, etc. The output interface 112 is configured to receive data representing the single-stream output data 140 from the processor(s) 104 and to send the single-stream output data 140 to the output device(s). To illustrate, in implementations in which the single-stream output data 140 includes audio data, the speaker(s) 142 are configured to output audio of the single-stream output data 140. In implementations in which the single-stream output data 140 includes video data, the display device(s) 146 are configured to output video of the single-stream output data 140.

The processor(s) 104 are configured to receive the single-stream data 120 and to generate the single-stream output data 140 based on multi-stream processing of the single-stream data 120. In the example illustrated in FIG. 1, the processor(s) 104 include a multi-stream augmented data generator 160, a multi-stream data processing unit 164, and a channel reducer 168. Each of the multi-stream augmented data generator 160, the multi-stream data processing unit 164, and the channel reducer 168 may include or correspond to dedicated hardware, instructions that are executable by the processor(s) 104, or a combination thereof, to perform the various operations described herein. In a particular example, the processor(s) 104 include, correspond to, or are included in an NPU.

The processor(s) 104 are configured to detect the single-stream data 120 that may be received via the input interface 106 and to provide the single-stream data 120 to the multi-stream augmented data generator 160. The multi-stream augmented data generator 160 is configured to generate multi-stream augmented data 162 that includes one or more modified versions of the single-stream data 120. For example, the multi-stream augmented data generator 160 is configured to apply one or more first operations on the single-stream data 120 to generate the one or more modified versions of the single-stream data 120, as described further below. According to an aspect, the first operation(s) produce modified versions of the single-stream data 120 that are equivalent to, but numerically different from, the single-stream data 120. Examples of the first operation(s) include a frequency-domain phase shift, a frequency-domain group phase shift, a time-domain shift, or applying a gain, each of which is described in further detail below.

The multi-stream data processing unit 164 is configured to process the multi-stream augmented data 162 to generate multiple output channels 166. In some implementations, the multi-stream data processing unit 164 includes one or more trained models, depicted as the network 170, that processes each stream of the multi-stream augmented data 162 in parallel and that uses the same network weights 114 for each stream of the multi-stream augmented data 162. Examples of trained models include machine-learning models, such as neural networks, adaptive neuro-fuzzy inference systems, support vector machines, decision trees, regression models, Bayesian models, or Boltzmann machines, or ensembles, variants, or other combinations thereof. Variants of decision trees include, for example and without limitation, random forests, boosted decision trees, etc. Variants of neural networks include, for example and without limitation, transformers, self-attention networks, convolutional neural networks, deep neural networks, deep belief networks, etc.

In some examples, the network 170 performs multi-stream processing at the multi-stream data processing unit 164 and may include, without limitation, recurrent neural networks (RNNs) (e.g., neural networks with one or more recurrent layers, one or more long short-term memory (LSTM) layers, one or more Gated Recurrent Unit (GRU) layers), recurrent convolutional neural networks (RCNNs), self-attention networks (e.g., transformers), other machine-learning models that are adapted to process time-series data in a temporally dynamic manner, or variants, ensembles, or combinations thereof.

The channel reducer 168 is configured to reduce the multiple output channels 166 to produce the single-stream output data 140. For example, to reduce the multiple output channels 166, the channel reducer 168 may be configured to perform one or more second operations on the output channels 166 to generate adjusted output channel data, as described further below. The second operation(s) correspond to inverse operations of the first operation(s) applied by the multi-stream augmented data generator 160. After performing the second operation(s), the channel reducer 168 combines the adjusted output channel data (e.g., averages values from the multiple adjusted channels) to generate the single-stream output data 140.

During operation, in an illustrative implementation, the single-stream data 120 includes audio data. In an example, the single-stream data 120 includes single-channel audio data captured by the microphone 126. In other examples, the single-stream data 120 includes dual-channel audio data (e.g., captured by two microphones 126) or multi-channel audio data (e.g., captured by more than two microphones 126). The multi-stream augmented data generator 160 processes the single-stream data 120 to generate the multi-stream augmented data 162 based on the single-stream data 120.

Continuing the above example, the multi-stream augmented data 162 is input to the multi-stream data processing unit 164, and the multi-stream data processing unit 164 performs noise reduction on each of the streams of the multi-stream augmented data 162, so that each of the output channels 166 corresponds to a noise-reduced version of a corresponding stream of the multi-stream augmented data 162. The channel reducer 168 processes and combines the output channels 166 to generate the single-stream output data 140. The single-stream output data 140 includes a noise-reduced version of the audio data.

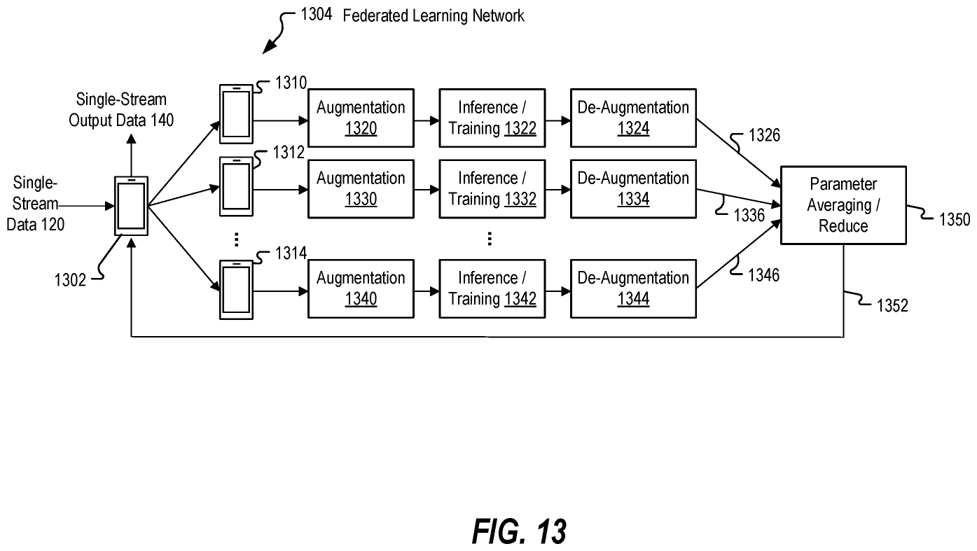

In some implementations, the modem 110 is configured to receive the single-stream data 120 from a second device 152 via wireless transmission over a communication channel 150. To illustrate, the communication channel 150 may include or correspond to a wired connection between two or more devices, a wireless connection between the two or more devices, or both. The single-stream data 120 may be received in connection with a federated learning network, as described further with reference to FIG. 13, and the processor(s) 104 may also be configured to send the single-stream output data 140 to the second device 152 via the modem 110. In some implementations, the single-stream output data 140 is provided to the modem 110 for transmission to the device 152 via the communication channel 150, such as for playback at one or more playback devices coupled to or included in the second device 152.

While the description above has focused primarily on examples in which the single-stream data 120 represents audio data, in some implementations, the single-stream data 120 may include or correspond to images or video data, or may include or correspond to one or more types of non-media data, such as motion sensor data or any other type of time-series data. Although the description above describes the multi-stream data processing unit 164 performing noise reduction, in other implementations the multi-stream data processing unit 164 performs one or more other types of processing instead of, or in addition to, noise reduction.

In some implementations, the network 170 is trained using multi-stream augmented training data, such as during a training operation performed at the device 102, at one or more other devices, or a combination thereof. For example, the processor(s) 104 can be configured to train the network 170 using multi-stream augmented training data and, after training, the processor(s) 104 can use the trained network 170 to process the multi-stream augmented data 162 during an inference operation (e.g., processing the single-stream data 120). In other implementations, the network 170 is trained using single-stream training data (e.g., bypassing the multi-stream augmented data generator 160 and the channel reducer 168), such as during a training operation performed at the device 102, at one or more other devices, or a combination thereof. For example, the processor(s) 104 can be configured to train the network 170 using single-stream augmented training data and, after training, the processor(s) 104 can use the trained network 170 to process the multi-stream augmented data 162 during an inference operation.

The system 100 thus facilitates processing of the single-stream data 120 based on generating and processing multi-stream augmented data 162. By increasing the number of streams that are processed at the recurrent network 170 but using the same set of network weights 114 for each stream, improved results are achieved at the single-stream output data 140 without substantially increasing the memory bandwidth used to transfer the network weights 114 from the memory 108 to the processor(s) 104, as compared to processing the single-stream data 120 without multi-stream augmentation.

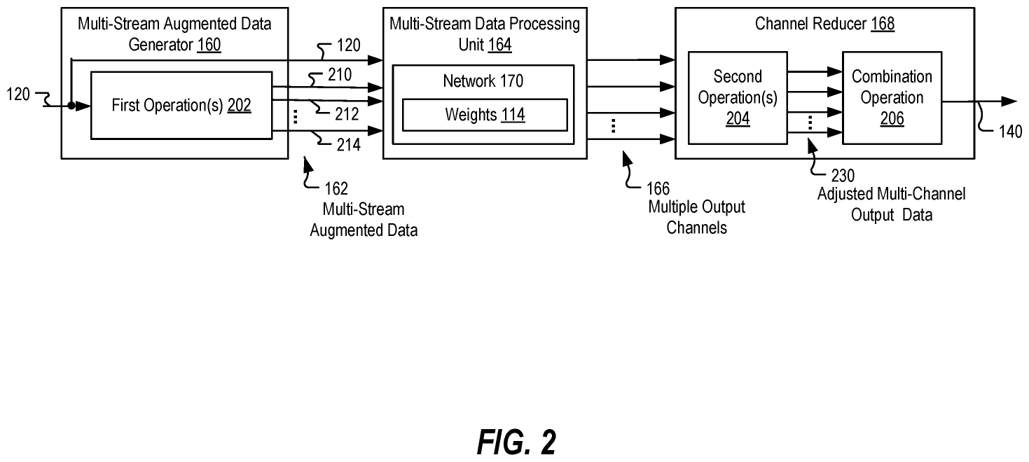

FIG. 2 is a diagram of particular aspects of the system of FIG. 1, in accordance with some examples of the present disclosure. In particular, FIG. 2 highlights an example of the multi-stream augmented data generator 160, the multi-stream data processing unit 164, and the channel reducer 168, according to a particular implementation.

In the example illustrated in FIG. 2, the multi-stream augmented data generator 160 generates the multi-stream augmented data 162 that includes one or more modified versions of the single-stream data 120, illustrated as a first modified version 210, a second modified version 212, and one or more other modified versions including a modified version 214. As illustrated, the multi-stream augmented data generator 160 is configured to perform one or more first operations 202 on the single-stream data 120 to generate the one or more modified versions 210-214 of the single-stream data 120. Examples of the first operation(s) include frequency-domain phase shifting, frequency-domain group phase shifting, gain adjustment, and time-domain shifting, as described further below.

In some implementations, the multi-stream augmented data 162 includes the single-stream data 120. For example, the single-stream data 120 can bypass the first operation(s) 202 as illustrated, or one or more of the first operation(s) 202 can be performed that do not alter the single-stream data 120 (e.g., by applying a gain of 1, or a delay of 0, etc., to the single-stream data 120). However, in other implementations, the multi-stream augmented data 162 may not include the single-stream data 120 (e.g., each stream of the multi-stream augmented data 162 is distinct from the single-stream data 120).

The multi-stream data processing unit 164 processes the multi-stream augmented data 162 to generate the output channels 166, and the channel reducer 168 processes the output channels 166 to generate the single-stream output data 140. To reduce the multiple output channels 166 into a single output stream, the channel reducer 168 is configured to perform one or more second operations 204 on at least one of the multiple output channels 166 to generate adjusted multi-channel output data 230, and perform a combination operation 206 on channels of the adjusted multi-channel output data 230 to generate the single-stream output data 140.

The one or more second operations 204 correspond to inverse operations of the one or more first operations 202. As used herein, an “inverse operation” functions to reverse a change that was performed by a prior operation. For example, if a first operation applies a gain of 2 to a signal, the inverse operation of that first operation applies a gain of 0.5. As another example, if a first operation applies a temporal shift or phase shift of 1 unit to a signal, the inverse operation of that first operation applies a temporal shift or phase shift of −1 unit.

In a particular example, the combination operation 206 includes averaging values of the channels of the adjusted multi-channel output data 230. For example, the combination operation 206 may perform an averaging operation (e.g., arithmetic mean) on a first sample or data unit of each of the channels of the adjusted multi-channel output data 230 to generate a first sample or data unit of the single-stream output data 140, perform the averaging operation on a second sample or data unit of each of the channels of the adjusted multi-channel output data 230 to generate a second sample or data unit of the single-stream output data 140, etc.

Generating the multi-stream augmented data 162 provides a diversity of equivalent but distinct streams of data for processing by the network 170. As a result, one or more features or characteristics in the single-stream data 120 may be presented to the network 170 in a variety of resolutions, timescales, etc., in the various streams of the multi-stream augmented data 162, enabling a more robust overall performance of the network 170 with respect to such features or characteristics. For example, processing of one or more of the multiple output channels 166 may have improved results (e.g., greater noise reduction) as compared to processing the single-stream data 120. Performing the second operation(s) 204 reverses the changes applied by the first operation(s) 202 and restores the output channels 166 to common condition (e.g., realigned in time, returned to original gain levels, etc.), which enables the combination operation 206 to combine the adjusted multi-channel output data 230 to form the single-stream output data 140.

In some implementations, the multi-stream augmented data 162 includes M streams, where M is an integer greater than 1. In experiments in which the network 170 performs single channel noise suppression for voice calls using different values of M (and without increasing the number of network weights 114), it has been observed that larger values of M result in increased noise-reduction performance as compared to smaller values of M. This result is observed for cases in which the network 170 is trained using single-stream training data and is also observed to a greater extent for cases in which the network 170 is trained using multi-stream augmented data. In one example, a noise-reduction performance for M=12 has been observed to perform substantially similar (e.g., a Perceptual Objective Listening Quality Analysis (POLQA) score within 1-2% for handset voice call data) or better (e.g., a significantly higher POLQA score for hands-free voice call data) noise reduction performance as compared to processing single stream audio data using a similar network that has approximately double the number of network weights. Thus, the multi-stream augmentation techniques described herein can provide similar or improved performance while using approximately half as many weights.

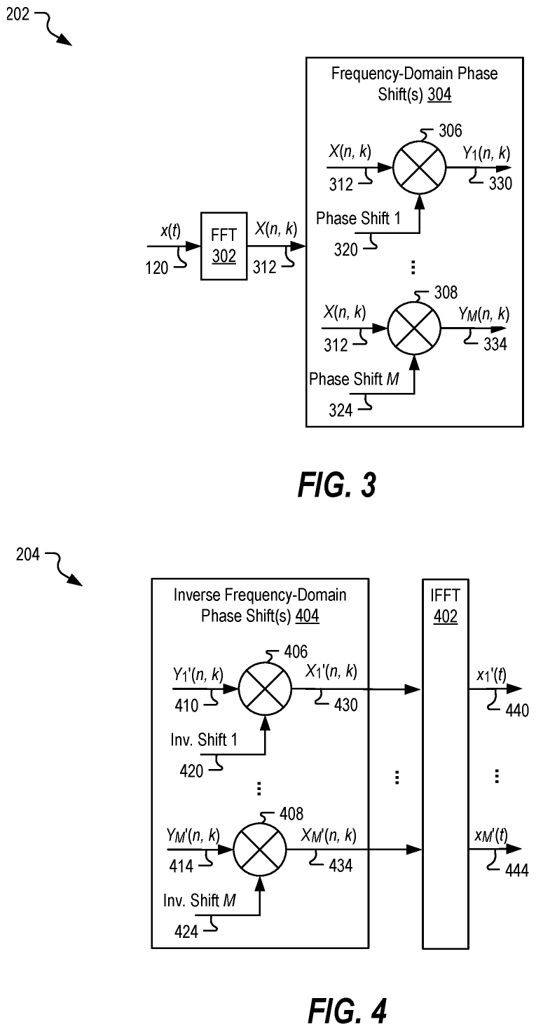

FIG. 3 is a diagram of particular aspects of the system of FIG. 1, in accordance with some examples of the present disclosure. In particular, FIG. 3 highlights a first example of the first operations 202 that may be performed by the multi-stream augmented data generator 160, according to a particular implementation.

In the example illustrated in FIG. 3, the first operation(s) 202 include performing a frequency domain transform, illustrated as a fast Fourier transform (FFT) 302, and one or more frequency-domain phase shifts 304. The FFT 302 processes the single-stream data 120, denoted x(t), to generate a frequency-domain version 312 of the single-stream data 120. The frequency-domain version 312 is denoted X(n, k), where n indicates a sequence index, and k indicates a bin index.

The frequency-domain phase shift(s) 304 include applying different phase shifts to the frequency-domain version 312 to generate multiple sets of phase-shifted data. For example, a first phase shift 320 (e.g., a constant phase shift to all frequency bins) can be applied, via a multiplier 306, to the frequency-domain version 312 to generate first phase-shifted data 330, denoted Y₁(n, k). The first phase shift 320 can be applied as e^{jφ}, where j represents the square root of −1 and φ represents the constant phase shift. Other phase shifts (e.g., other values of φ) can be applied to the frequency-domain version 312 to generate other phase-shifted data, including an Mth phase shift 324 that is applied, via a multiplier 308, to the frequency-domain version 312 to generate Mth phase-shifted data 334, denoted Y_{M}(n, k). In this example, the resulting M sets of phase shifted data 330-334 form the multi-stream augmented data 162.

FIG. 4 is a diagram of particular aspects of the system of FIG. 1, in accordance with some examples of the present disclosure. In particular, FIG. 4 highlights a first example of the second operations 204 that may be performed by the channel reducer 168, according to a particular implementation.

In the example illustrated in FIG. 4, the second operation(s) 204 include performing one or more inverse frequency-domain phase shifts 404 to individual channels of the output channels 166 that reverse the frequency-domain phase shift(s) 304 illustrated in FIG. 3. For example, a first inverse phase shift 420 (e.g., a constant phase shift to all frequency bins) can be applied, via a multiplier 406, to data of a first channel of the output channels 166, denoted Y₁′(n, k) 410, to generate first adjusted data, denoted X₁′(n, k) 430. In the illustrated implementation, Y₁′ (n, k) 410 corresponds to a result of processing Y₁(n, k) 330 of FIG. 3 at the multi-stream data processing unit 164, and the first inverse phase shift 420 can be applied as e^{-jφ}.

Other inverse phase shifts can be applied to the other channels of the output channels 166 to generate other adjusted data, including an Mth inverse phase shift 424 that is applied, via a multiplier 408, to data of an Mth channel of the output channels 166, denoted Y_{M}′(n, k) 414, to generate Mth adjusted data, denoted X_{M}′(n, k) 434. In the illustrated implementation, Y_{M}′(n, k) 414 corresponds to a result of processing Y_{M}(n, k) 334 of FIG. 3 at the multi-stream data processing unit 164, and the Mth inverse phase shift 424 can be applied to reverse the Mth phase shift 324.

In the example illustrated in FIG. 4, the second operation(s) 204 also include performing an inverse transform, illustrated as an inverse FFT (IFFT) 402, to each of the frequency-domain adjusted data 430-434 to generate time-domain adjusted data 440-444. For example, X₁′(n, k) 430 is processed to generate first time-domain adjusted data x₁′(t) 440, and X_{M}′(n, k) 434 is processed to generate Mth time-domain adjusted data x_{M}′(t) 444. In this example, the resulting M sets of time-domain adjusted data 440-444 form the adjusted multi-channel output data 230.

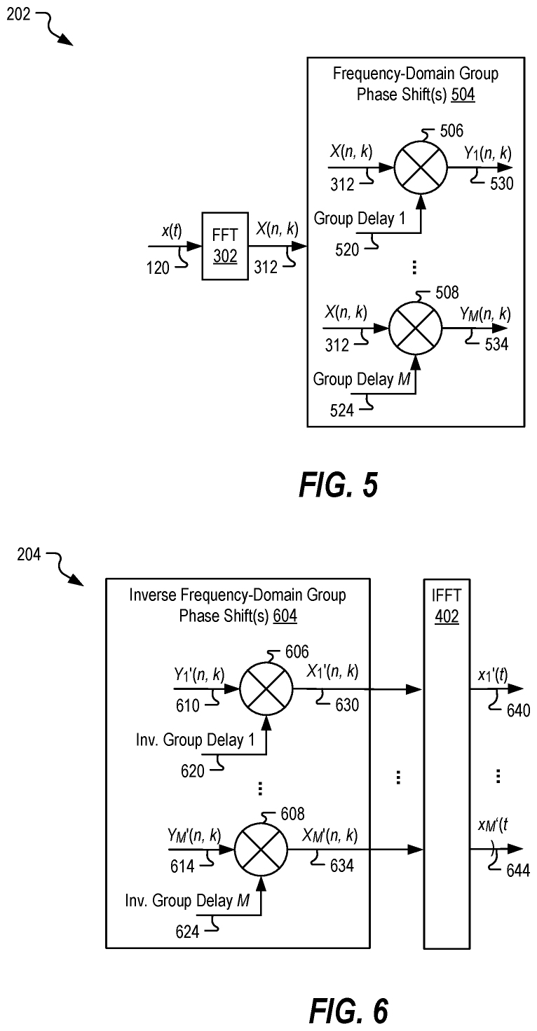

FIG. 5 is a diagram of particular aspects of the system of FIG. 1, in accordance with some examples of the present disclosure. In particular, FIG. 5 highlights a second example of the first operations 202 that may be performed by the multi-stream augmented data generator 160, according to a particular implementation.

In the example illustrated in FIG. 5, the first operation(s) 202 include performing a frequency domain transform, illustrated as the FFT 302, and one or more frequency-domain group phase shifts 504. The FFT 302 processes the single-stream data x(t) 120 to generate the frequency-domain version X(n, k) 312 of the single-stream data 120.

The frequency-domain group phase shift(s) 504 include applying different sets of group phase shifts to the frequency-domain version X(n, k) 312 to generate multiple sets of group phase-shifted data. For example, a first group delay 520 can be applied, via a multiplier 506, to the frequency-domain version X(n, k) 312 to generate first group-delayed data Y₁(n, k) 530. The first group delay 520 can be applied in the form of exp(j2πkτ/N) for each frequency bin, where exp( ) represents an exponential function, k represents the bin index, N is the FFT size, and τ is the group delay. According to some implementations, the absolute group delay |τ| is much smaller than the window size. Other group delays (e.g., other values of τ) can be applied to the frequency-domain version X(n, k) 312 to generate other group-delayed data, including an Mth group delay 524 that is applied, via a multiplier 508, to the frequency-domain version X(n, k) 312 to generate Mth group-delayed data Y_{M}(n, k) 534. In this example, the resulting M sets of group-delayed data 530-534 form the multi-stream augmented data 162.

FIG. 6 is a diagram of particular aspects of the system of FIG. 1, in accordance with some examples of the present disclosure. In particular, FIG. 6 highlights a second example of the second operations 204 that may be performed by the channel reducer 168, according to a particular implementation.

In the example illustrated in FIG. 6, the one or more second operations 204 include performing one or more inverse frequency-domain group phase shifts 604 to individual channels of the output channels 166 that reverse the frequency-domain group phase shift(s) 504 illustrated in FIG. 5. For example, a first inverse group delay 620 can be applied, via a multiplier 606, to data of a first channel of the output channels 166, denoted Y₁′(n, k) 610, to generate first adjusted data, denoted X₁′(n, k) 630. In the illustrated implementation, Y₁′(n, k) 610 corresponds to a result of processing Y₁(n, k) 530 of FIG. 5 at the multi-stream data processing unit 164, and the first inverse group delay 620 can be applied in the form of exp(−j2πkτ/N) for each frequency bin.

Other inverse group delays can be applied to the other channels of the output channels 166 to generate other adjusted data, including an Mth inverse group delay 624 that is applied, via a multiplier 608, to data of an Mth channel of the output channels 166, denoted Y_{M}′(n, k) 614, to generate Mth adjusted data, denoted X_{M}′(n, k) 634. In the illustrated implementation, Y_{M}′(n, k) 614 corresponds to a result of processing Y_{M}(n, k) 534 of FIG. 5 at the multi-stream data processing unit 164, and the Mth inverse group delay 624 can be applied to reverse the Mth group delay 524.

In the example illustrated in FIG. 6, the second operation(s) 204 also include performing an inverse transform, illustrated as the IFFT 602, to each of the frequency-domain adjusted data 630-634 to generate time-domain adjusted data 640-644. For example, X₁′(n, k) 630 is processed to generate first time-domain adjusted data x₁′(t) 640, and X_{M}′(n, k) 634 is processed to generate Mth time-domain adjusted data x_{M}′(t) 644. In this example, the resulting M sets of time-domain adjusted data 640-644 form the adjusted multi-channel output data 230.

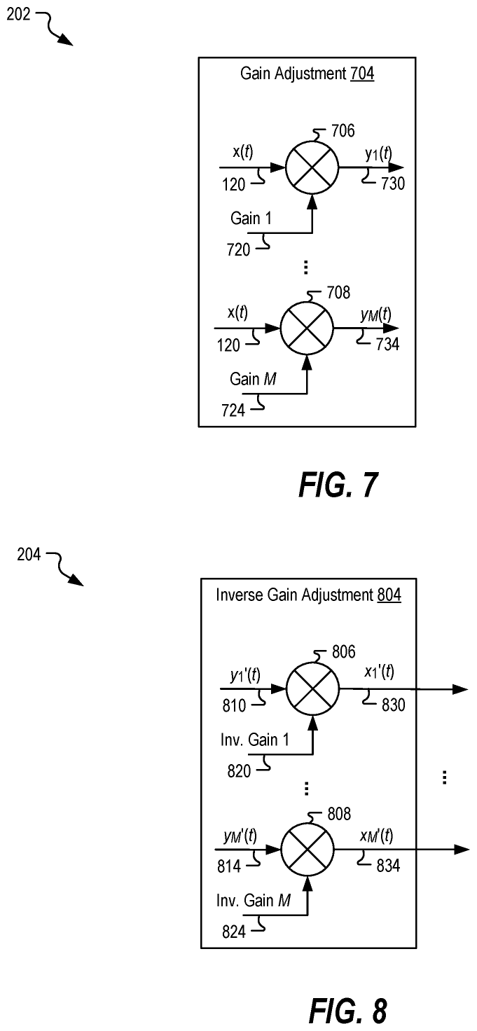

FIG. 7 is a diagram of particular aspects of the system of FIG. 1, in accordance with some examples of the present disclosure. In particular, FIG. 7 highlights a third example of the first operations 202 that may be performed by the multi-stream augmented data generator 160, according to a particular implementation.

In the example illustrated in FIG. 7, the first operation(s) 202 include performing one or more gain adjustments 704. The gain adjustment(s) 704 include applying different gains to the single-stream data x(t) 120 to generate multiple sets of gain-adjusted data. For example, a first gain g 720 can be applied, via a multiplier 706, to the single-stream data x(t) 120 to generate first gain-adjusted data y₁(t) 730. Other gains can be applied to the single-stream data x(t) 120 to generate other gain-adjusted data, including an Mth gain 724 that is applied, via a multiplier 708, to the single-stream data x(t) 120 to generate Mth gain-adjusted data y_{M}(t) 734. In this example, the resulting M sets of gain-adjusted data 730-734 form the multi-stream augmented data 162.

FIG. 8 is a diagram of particular aspects of the system of FIG. 1, in accordance with some examples of the present disclosure. In particular, FIG. 8 highlights a third example of the second operations 204 that may be performed by the channel reducer 168, according to a particular implementation.

In the example illustrated in FIG. 8, the one or more second operations 204 include performing one or more inverse gain adjustments 804 to individual channels of the output channels 166 that reverse the gain adjustment(s) 704 illustrated in FIG. 7. For example, a first inverse gain 820 can be applied, via a multiplier 806, to data of a first channel of the output channels 166, denoted y₁′(t) 810, to generate first adjusted data, denoted x₁′(t) 830. In the illustrated implementation, y₁′(t) 810 corresponds to a result of processing y₁(t) 730 of FIG. 7 at the multi-stream data processing unit 164, and the first inverse gain 820 can be applied in the form of 1/g.

Other inverse gains can be applied to the other channels of the output channels 166 to generate other adjusted data, including an Mth inverse gain 824 that is applied, via a multiplier 808, to data of an Mth channel of the output channels 166, denoted y_{M}′ (t) 814, to generate Mth adjusted data, denoted x_{M}′(t) 834. In the illustrated implementation, y_{M}′(t) 814 corresponds to a result of processing y_{M}(t) 734 of FIG. 7 at the multi-stream data processing unit 164, and the Mth inverse gain 824 can be applied as an inverse (e.g., reciprocal) of the Mth gain 724. In this example, the resulting M sets of adjusted data 840-844 form the adjusted multi-channel output data 230.

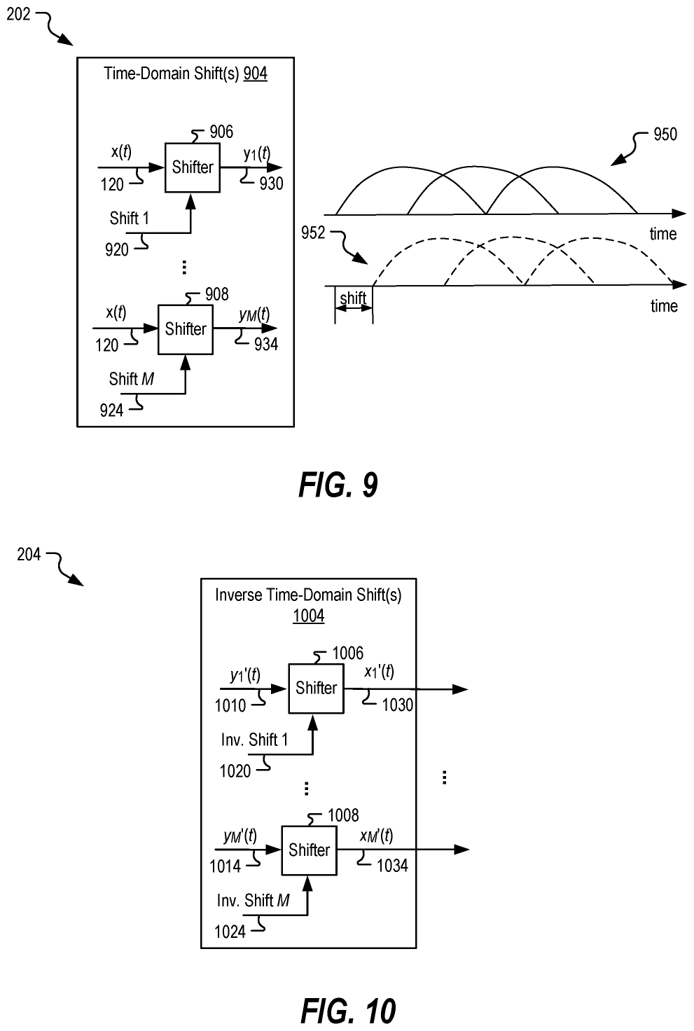

FIG. 9 is a diagram of particular aspects of the system of FIG. 1, in accordance with some examples of the present disclosure. In particular, FIG. 9 highlights a fourth example of the first operations 202 that may be performed by the multi-stream augmented data generator 160, according to a particular implementation.

In the example illustrated in FIG. 9, the one or more first operations 202 include performing one or more time-domain shifts 904. The time-domain shift(s) 904 include applying different shifts (e.g., forward or backward) to the single-stream data x(t) 120 to generate multiple sets of shifted data. In framewise processing, this can be achieved by halving (or ⅓, or ¼, etc.) the hop size while keeping the same window function. For example, a first diagram 950 graphically illustrates a simplified example of a set of window functions associated with framewise processing, and a second diagram 952 illustrates the set of window functions after application of a shift.

In the illustrated implementation of the time-domain shift(s) 904, a first shift amount 920 can be applied, via a shifter 906, to the single-stream data x(t) 120 to generate first shifted data y₁(t) 930. Other shift amounts can be applied to the to the single-stream data x(t) 120 to generate other shifted data, including an Mth shift amount 924 that is applied, via a shifter 908, to the single-stream data x(t) 120 to generate Mth shifted data y_{M}(t) 934. In this example, the resulting M sets of shifted data 930-934 form the multi-stream augmented data 162.

FIG. 10 is a diagram of particular aspects of the system of FIG. 1, in accordance with some examples of the present disclosure. In particular, FIG. 10 highlights a fourth example of the second operations 204 that may be performed by the channel reducer 168, according to a particular implementation.

In the example illustrated in FIG. 10, the one or more second operations 204 include performing one or more inverse time-domain shifts 1004 to individual channels of the output channels 166 that reverse the time-domain shift(s) 904 illustrated in FIG. 9. For example, a first inverse shift amount 1020 can be applied, via a shifter 1006, to data of a first channel of the output channels 166, denoted y₁′(t) 1010, to generate first adjusted data, denoted x₁′(t) 1030. In the illustrated implementation, y₁′(t) 1010 corresponds to a result of processing y₁(t) 930 of FIG. 9 at the multi-stream data processing unit 164, and the first inverse shift amount 1020 can have the same magnitude, but opposite direction, as the first shift amount 920.

Other inverse shifts can be applied to the other channels of the output channels 166 to generate other adjusted data, including an Mth inverse shift amount 1024 that is applied, via a shifter 1008, to data of an Mth channel of the output channels 166, denoted y_{M}′(t) 1014, to generate Mth adjusted data, denoted x_{M}′(t) 1034. In the illustrated implementation, y_{M}′(t) 1014 corresponds to a result of processing y_{M}(t) 934 of FIG. 9 at the multi-stream data processing unit 164, and the Mth inverse shift amount 1024 can be applied as an inverse (e.g., equal magnitude, opposite direction) of the Mth shift amount 924. In this example, the resulting M sets of adjusted data 1040-1044 form the adjusted multi-channel output data 230.

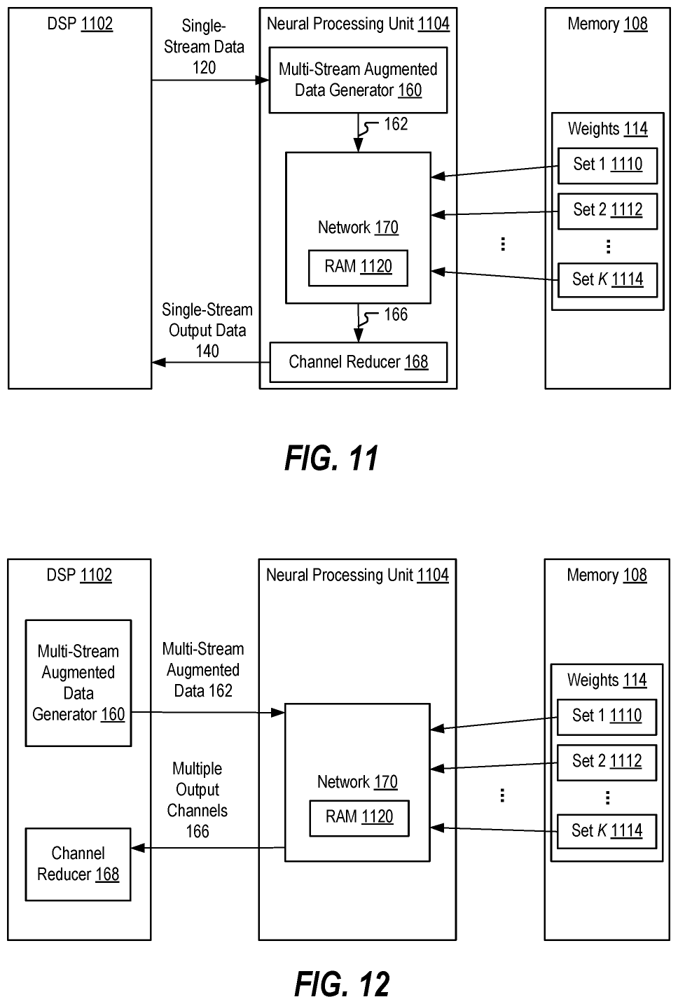

FIG. 11 is a diagram of particular aspects of the system of FIG. 1, in accordance with some examples of the present disclosure. In particular, FIG. 11 highlights a first example of the network 170 implemented in an NPU 1104, according to a particular implementation.

In the example illustrated in FIG. 11, the NPU 1104 includes the multi-stream augmented data generator 160, the network 170, and the channel reducer 168. For example, the processor(s) 104 may be included in the NPU 1104. The NPU 1104 is coupled to another processor, illustrated as a digital signal processor (DSP) 1102. However, in other implementations, the NPU 1104 can be coupled to one or more other types of processors, such as a central processing unit (CPU) as an illustrative, non-limiting example.

The NPU 1104 is also coupled to the memory 108 and is configured to access the network weights 114 in conjunction with processing the multi-stream augmented data 162. However, an amount of storage capacity in the NPU 1104, illustrated as random access memory (RAM) 1120, may be insufficient to store the entire set of network weights 114 on-chip. As a result, the NPU 1104 may sequentially access a first set 1110 of the network weights 114 from the memory 108 to perform a first portion of processing the multi-stream augmented data 162, a second set 1112 of the network weights 114 to perform a second portion of the processing, etc., up to a Kth set 1114 of the network weights 114 to perform a Kth portion of the processing of the multi-stream augmented data 162 (where K is an integer greater than 1).

For example, the first set 1110 may correspond to weights of one or more first layers of the network 170. After processing a first frame of each stream of the multi-stream augmented data 162 in parallel at the one or more first layers using the first set 1110 of the network weights 114, the NPU 1104 may retrieve the second set 1112 from the memory 108 and store the second set 1112 in the RAM 1120, overwriting the first set 1110. The second set 1112 may correspond to weights of one or more second layers of the network 170, which are used to continue the parallel processing of the first frame of each of the streams of the multi-stream augmented data 162. Processing continues until the Kth set 1114, corresponding to one or more final layers of the network 170, has been stored to the RAM 1120 and used to complete processing of the first frame of each of the streams of the multi-stream augmented data 162, resulting in generation of a first frame of each of the multiple output channels 166. After generating the first frame of each of the multiple output channels 166, the first set 1110 is again loaded to the RAM 1120, and the NPU 1104 begins processing of the second frame of each stream of the multi-stream augmented data 162 in parallel at the one or more first layers.

For real-time processing, such as real-time audio noise reduction, the NPU 1104 has excess computational capacity, but performance of the NPU 1104 can be constrained due to the size of the network 170 in terms of the number of network weights 114, memory bandwidth available to transfer the network weights 114 from the memory 108 to the NPU 1104, power consumption associated with transferring the network weights 114, or a combination thereof. Although increasing a size of the RAM 1120 can reduce or eliminate repeating transfer of the sets 1110-1114 of weights for each sequential input frame of the multi-stream augmented data 162, the size of the RAM 1120 can be constrained based on factors such as chip size, chip cost, and power consumption, particularly when the NPU 1104 is implemented in portable electronic devices.

By using the multi-stream augmented data 162, performance of the network 170 can be enhanced by using the excess computational capacity of the NPU 1104 to increase the number of streams processed in parallel by the network 170 without increasing the number of network weights 114.

FIG. 12 is a diagram of particular aspects of the system of FIG. 1, in accordance with some examples of the present disclosure. In particular, FIG. 12 highlights a second example of the network 170 implemented in the NPU 1104, according to a particular implementation.

In the example illustrated in FIG. 12, the multi-stream augmented data generator 160 and the channel reducer 168 are implemented at the DSP 1102 instead of at the NPU 1104. The multi-stream augmented data 162 is transferred from the DSP 1102 to the NPU 1104 and processed as described with reference to FIG. 11. After completion of processing of one or more frames of the multi-stream augmented data 162 at the NPU 1104 (e.g., after a first frame of each channel of the multiple output channels 166 has been generated), the one or more frames of the output channels 166 are transferred from the NPU 1104 to the channel reducer 168 at the DSP 1102, which generates a corresponding frame of the single-stream output data 140.

FIG. 13 is a diagram illustrating particular aspects of operations performed by the system of FIG. 1, in accordance with some examples of the present disclosure. In particular, FIG. 13 highlights an example of communication between multiple devices using components of the system 100 in conjunction with a federated learning network 1304, according to a particular implementation.

In the example illustrated in FIG. 13, the federated learning network 1304 includes a primary device 1302 (e.g., a user device) and multiple other devices, illustrated as a device 1310, a device 1312, and one or more other devices including a device 1314. In a particular implementation, one or more of the devices 1310-1314 correspond to edge devices, and the devices 1310-1314 may include a variety of computational capabilities. In an example, one or more of the devices 1310-1314 corresponds to a server, a personal computer, a portable electronic device, or one or more other devices coupled to the device 1302 via one or more wired or wireless networks.

In a particular implementation, each of the devices 1310-1312 is configured to perform multi-stream augmentation and reduction functionality in a similar manner as described for the device 102. For example, the device 1310 is configured to receive single-stream input data and to perform augmentation 1320 (e.g., as described for the multi-stream augmented data generator 160), network processing 1322 (such as performing inference, training, or both, at the network 170), and de-augmentation 1324 (e.g., as described for the channel reducer 168) to generate output data 1326 (e.g., the single-stream output data 140 of FIG. 1) which the device 1310 may send to the device 1302 via a modem (e.g., the modem 110). Similarly, the device 1312 is configured to perform augmentation 1330, network processing 1332 (e.g., inference, training, or both), and de-augmentation 1334 to generate output data 1336, and the device 1314 is configured to perform augmentation 1340, network processing 1342 (e.g., inference, training, or both), and de-augmentation 1344 to generate output data 1346.

According to some implementations, the devices 1310-1314 operate as a distributed computing network for performing signal processing. For example, the device 1302 can probe the local network environment for available nodes and send a copy of the single-stream data 120 to each of the nodes that is available (e.g., the devices 1310-1314). Each of the devices 1310-1314 locally processes the single-stream data 120 using that device's augmentation, network processing, and de-augmentation capabilities to generate respective sets of output data 1326, 1336, and 1346. Each of the sets of output data 1326, 1336, and 1346 includes a version of the single-stream output data 140 generated by a respective device 1310, 1312, and 1314 based on the single-stream data 120. The sets of output data 1326, 1336, and 1346 can be combined (e.g., reduced, such as via a weighted average or non-weighted average) at a parameter averaging/reduction operation 1350 to generate an output 1352. The parameter averaging/reduction operation 1350 can be performed at the device 1302, at one or more of the devices 1310-1314, or at another device.

The output 1352 is used by the device 1302 to generate the single-stream output data 140. In some implementations, the device 1302 does not perform signal processing on the single-stream data 120, and the single-stream output data 140 matches the output 1352. In other implementations, the device 1302 may correspond to the device 102 of FIG. 1 and may process the single-stream data 120 in parallel with the processing that is performed at the devices 1310-1314. For example, the device 1302 may include the output 1352 as an input the combination operation 206 at the channel reducer 168. As another example, the device 1302 may combine the single-stream output data generated at the channel reducer 168 with the output 1352 to generate the single-stream output data 140.

In some implementations, the device 1302 may communicate augmentation parameters to each of the devices 1310-1314 so that the devices 1310-1314 do not perform the same computations. For example, the device 1302 may perform augmentation and reduction using gain adjustments and may instruct the device 1310 to use frequency-domain phase shifting, instruct the device 1312 to use frequency-domain group phase shifting, and instruct the device 1314 to use time-domain shifting. By distributing processing among the multiple devices 1310-1314, the device 1302 may obtain the benefit of various different types of augmentation and reduction techniques to generate the single-stream output data 140.

In some implementations, the federated learning network 1304 is configured to perform distributed training to determine or update parameters associated with augmented multi-stream processing, such as the network weights 114. For example, the device 1310 may receive a copy of the parameters from the device 1302 and may perform a training operation on a local version of the network 170 using locally stored streams of data as training data to generate updated parameters. Similarly, the device 1312 may receive the copy of the parameters and may perform a training operation using streams of data stored locally at the device 1312 as training data to generate updated parameters, and the device 1314 may receive the copy of the parameters and perform a training operation using streams of data stored locally at the device 1314 as training data to generated updated parameters.

The updated parameters generated by the device 1310 may be included in the output data 1326, the updated parameters generated by the device 1312 may be included in the output data 1336, and the updated parameters generated by the device 1314 may be included in the output data 1346. The updated parameters can be combined (e.g., averaged) at the parameter averaging/reduction operation 1350 to generate an updated set of parameters that are included in the output 1352 that is provided to the device 1302. Because the data that is used as training data remains local to each of the devices 1310-1314, the updated set of parameters can be generated based on a wide variety of data from multiple devices without jeopardizing the privacy of any of the data using in training.

In some implementations, the device 1310-1314 are clustered or grouped according to computing power, such as by processor type. The clusters can be ranked and/or prioritized based on relative computing power. For example, when combining updated parameters from various clusters at the parameter averaging/reduction operation 1350, a weighted average may be used in which updates from clusters having stronger computing power may be given more weight as compared to updates clusters having relatively less computing power.

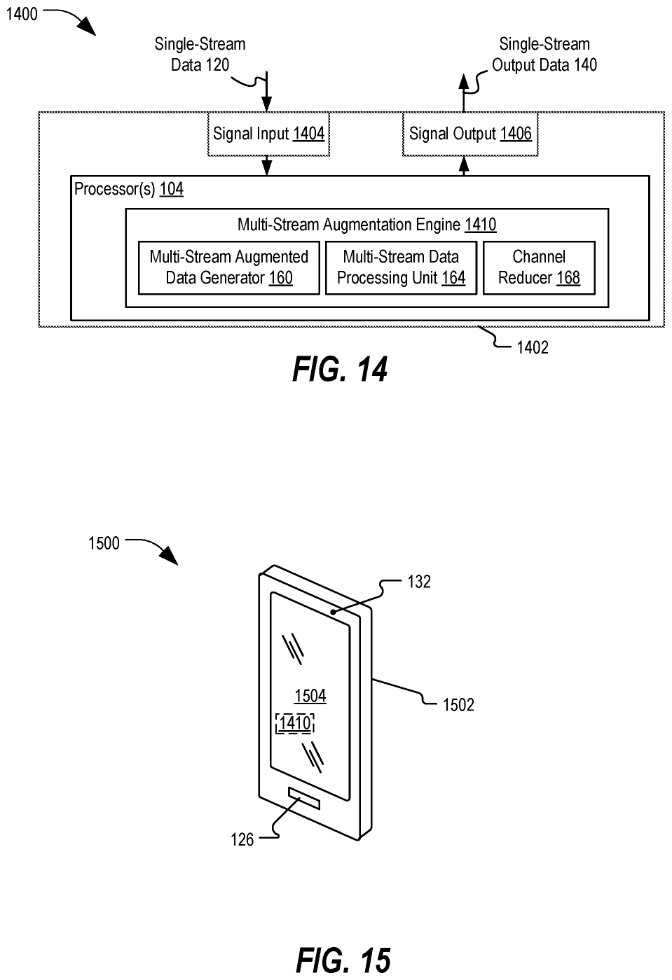

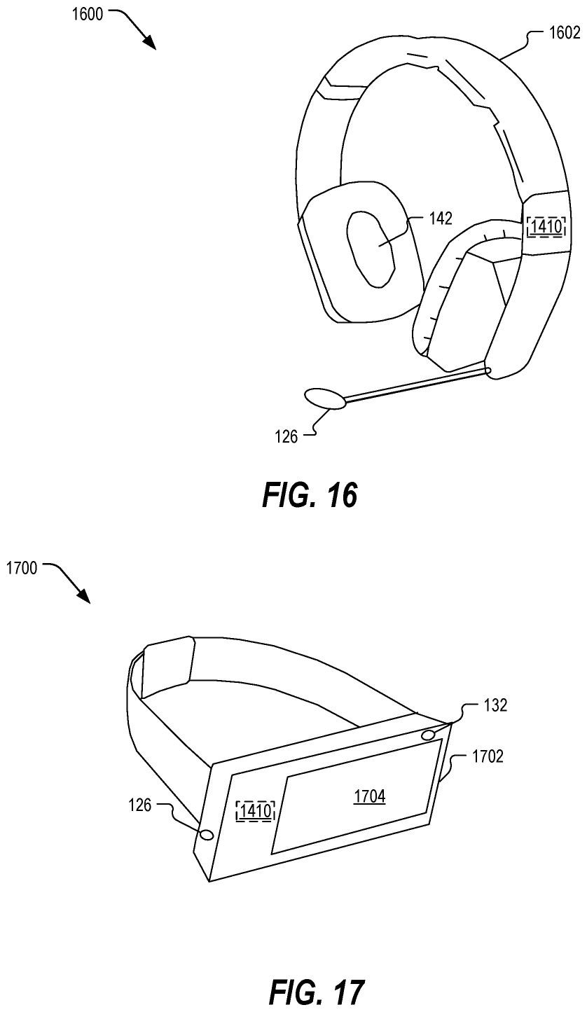

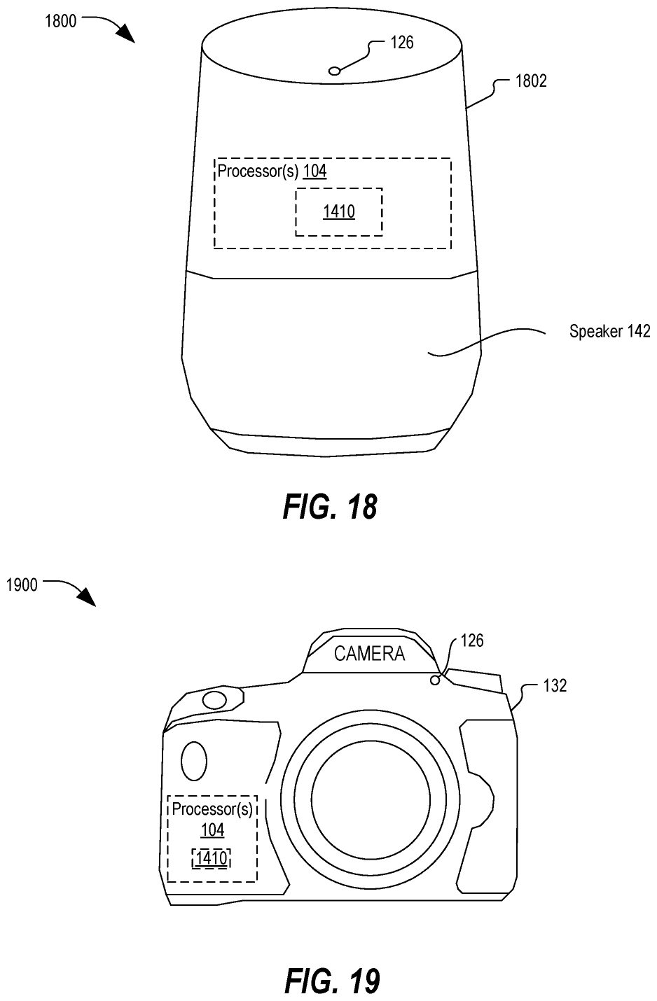

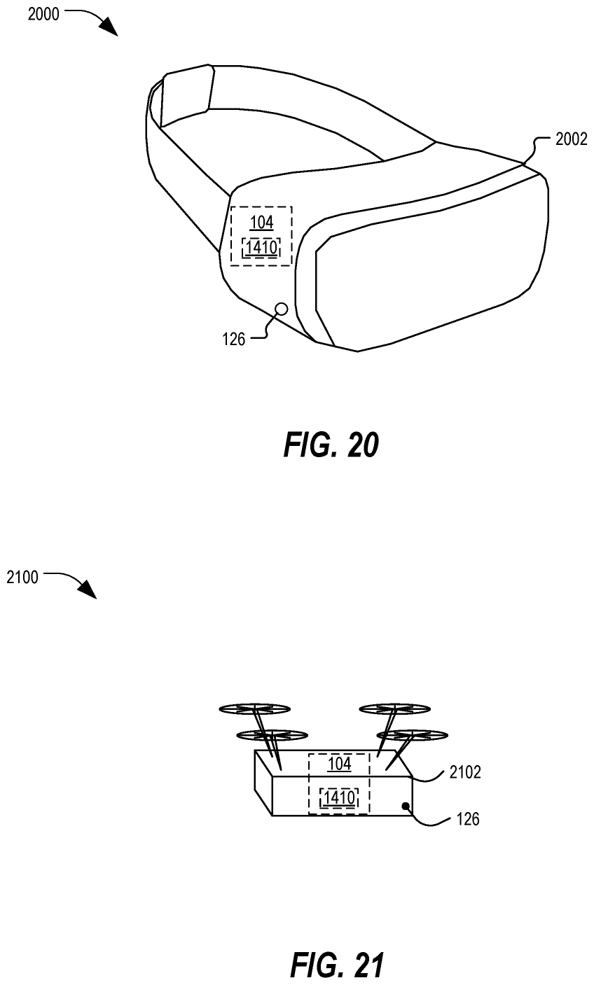

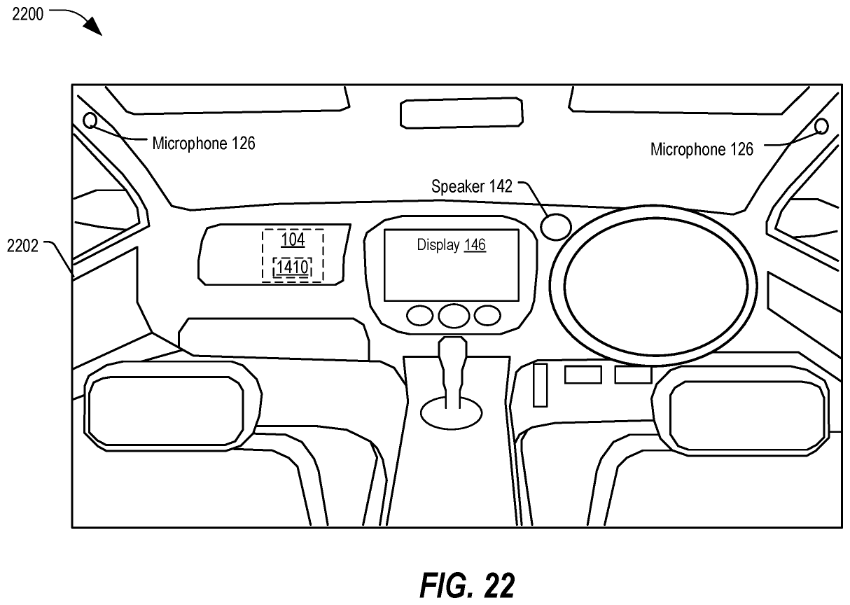

FIG. 14 depicts an implementation 1400 of the device 102 as an integrated circuit 1402 that includes the one or more processors 104. The integrated circuit 1402 also includes a signal input 1404, such as one or more bus interfaces, to enable the single-stream data 120 to be received for processing. The integrated circuit 1402 also includes a signal output 1406, such as a bus interface, to enable sending of an output signal, such as the single-stream output data 140. In the example illustrated in FIG. 14, the processor(s) 104 include a multi-stream augmentation engine 1410 that includes the multi-stream augmented data generator 160, the multi-stream data processing unit 164, and the channel reducer 168. The integrated circuit 1402 enables implementation of operations to perform multi-stream processing of single-stream data as a component in a system that includes microphones, such as a mobile phone or tablet as depicted in FIG. 15, a headset as depicted in FIG. 16, a wearable electronic device as depicted in FIG. 17, a voice-controlled speaker system as depicted in FIG. 18, a camera as depicted in FIG. 19, a virtual reality, mixed reality, or augmented reality headset as depicted in FIG. 20, or a vehicle as depicted in FIG. 21 or FIG. 22.

FIG. 15 depicts an implementation 1500 in which the device 102 includes a mobile device 1502, such as a phone or tablet, as illustrative, non-limiting examples.

The mobile device 1502 includes the microphone 126, the camera 132, and a display screen 1504. Components of the processor(s) 104, including the multi-stream augmentation engine 1410, are integrated in the mobile device 1502 and are illustrated using dashed lines to indicate internal components that are not generally visible to a user of the mobile device 1502. In a particular example, the multi-stream augmentation engine 1410 operates to perform multi-stream processing of an input media stream. For example, the microphone 126 may capture speech of a user of the mobile device 1502, and the multi-stream augmentation engine 1410 may process the captured speech to generate an output media stream corresponding to a noise-reduced version of the speech.

FIG. 16 depicts an implementation 1600 in which the device 102 includes a headset device 1602. The headset device 1602 includes the microphone 126. Components of the processor(s) 104, including multi-stream augmentation engine 1410, are integrated in the headset device 1602. In a particular example, the multi-stream augmentation engine 1410 operates to perform multi-stream processing of an input media stream. For example, the microphone 126 may capture speech of a user of the headset device 1602, and the multi-stream augmentation engine 1410 may process the captured speech to generate an output media stream corresponding to a noise-reduced version of the speech. The noise-reduced version of the speech may be used to generate an output media stream from one or more speakers 142 of the headset device 1602, or may be transmitted to another device (e.g., a mobile device, a game console, a voice assistant, etc.) to for playout of the output media stream.

FIG. 17 depicts an implementation 1700 in which the device 102 includes a wearable electronic device 1702, illustrated as a “smart watch.” The wearable electronic device 1702 includes the processor(s) 104 and a display screen 1704. Components of the processor(s) 104, including the multi-stream augmentation engine 1410, are integrated in the wearable electronic device 1702. In a particular example, the multi-stream augmentation engine 1410 operates to perform multi-stream processing of an input media stream. For example, the microphone 126 may capture speech of a user of the wearable electronic device 1702, and the multi-stream augmentation engine 1410 may process the captured speech to generate an output media stream corresponding to a noise-reduced version of the speech. The noise-reduced version of the speech may be used to generate an output at the display screen 1704 of the wearable electronic device 1702, such as in conjunction with a speech interface, or may be transmitted to another device (e.g., a mobile device, a game console, a voice assistant, etc.) for playout of the output media stream.

FIG. 18 is an implementation 1800 in which the device 102 includes a wireless speaker and voice activated device 1802. The wireless speaker and voice activated device 1802 can have wireless network connectivity and is configured to execute an assistant operation. The wireless speaker and voice activated device 1802 of FIG. 18 includes the processor(s) 104, which include the multi-stream augmentation engine 1410. Additionally, the wireless speaker and voice activated device 1802 includes the microphone 126 and the speaker 142. During operation, in response to receiving an input media stream including user speech, the multi-stream augmentation engine 1410 operates to perform multi-stream processing of the input media stream. For example, the microphone 126 may capture speech of a user of the wireless speaker and voice activated device 1802, and the multi-stream augmentation engine 1410 may process the captured speech to generate an output media stream corresponding to a noise-reduced version of the speech, which may be used in conjunction with a speech interface to provide instructions to the assistant operation.

FIG. 19 depicts an implementation 1900 in which the device 102 is integrated into or includes a portable electronic device that corresponds to the camera 132. In FIG. 19, the camera 132 includes the processor(s) 104 and the microphone 126. The processor(s) 104 include the multi-stream augmentation engine 1410. During operation, the camera 132, the microphone 126, or both, generate an input media stream and the multi-stream augmentation engine 1410 operates to perform multi-stream processing of the input media stream. For example, the microphone 126 may capture speech of a user of the camera 132, and the multi-stream augmentation engine 1410 may process the captured speech to generate an output media stream corresponding to a noise-reduced version of the speech, which may be used in conjunction with a speech interface to provide operating instructions to the camera 132. In another implementation, the multi-stream augmentation engine 1410 is configured to perform processing of a stream of image data, such as to perform jitter filtering, smear filtering, or one or more other types of processing, corresponding to video that is captured by the camera 132.

FIG. 20 depicts an implementation 2000 in which the device 102 includes a portable electronic device that corresponds to an extended reality headset 2002 (e.g., a virtual reality headset, a mixed reality headset, or an augmented reality headset, or a combination thereof). The extended reality headset 2002 includes the microphone 126 and the processor(s) 104. In a particular aspect, a visual interface device is positioned in front of the user's eyes to enable display of augmented reality, mixed reality, or virtual reality images or scenes to the user while the extended reality headset 2002 is worn. In a particular example, the visual interface device is configured to display a notification indicating user speech detected in an audio signal from the microphone 126. In a particular implementation, the processor(s) 104 include the multi-stream augmentation engine 1410. During operation, the microphone 126 may generate an input media stream including speech of a user of the extended reality headset 2002, and the multi-stream augmentation engine 1410 may process the captured speech to generate an output media stream corresponding to a noise-reduced version of the speech. The output media stream may be transmitted to an extended reality server or to other participants in a shared virtual environment, or may be used in conjunction with a speech interface to provide operating instructions to the extended reality headset 2002, as illustrative, non-limiting examples.

FIG. 21 depicts an implementation 2100 in which the device 102 corresponds to, or is integrated within, a vehicle 2102, illustrated as a manned or unmanned aerial device (e.g., a package delivery drone). The microphone 126 and the processor(s) 104 are integrated into the vehicle 2102. In a particular implementation, the processor(s) 104 include the multi-stream augmentation engine 1410. During operation, the microphone 126 may capture speech of a person near the vehicle 2102 (such as speech including delivery instructions from an authorized user of the vehicle 2102), and the multi-stream augmentation engine 1410 may process the captured speech to generate an output media stream corresponding to a noise-reduced version of the speech. The output media stream may be transmitted to another device (e.g., a server device), or may be used in conjunction with a speech interface to provide operating instructions or queries to the vehicle 2102, as illustrative, non-limiting examples.

FIG. 22 depicts another implementation 2200 in which the device 102 corresponds to, or is integrated within, a vehicle 2202, illustrated as a car. The vehicle 2202 includes the processor(s) 104, which include the multi-stream augmentation engine 1410. The vehicle 2202 also includes the microphone 126, the speaker 142, and the display device 146. The microphone 126 is positioned to capture utterances of an operator of the vehicle 2202 or a passenger of the vehicle 2202. During operation, the microphone 126 may capture speech of an operator or passenger of the vehicle 2102, and the multi-stream augmentation engine 1410 may process the captured speech to generate an output media stream corresponding to a noise-reduced version of the speech. The output media stream may be transmitted to another device (e.g., a server device), or may be used in conjunction with a speech interface to provide operating instructions or queries to the vehicle 2202, as illustrative, non-limiting examples.

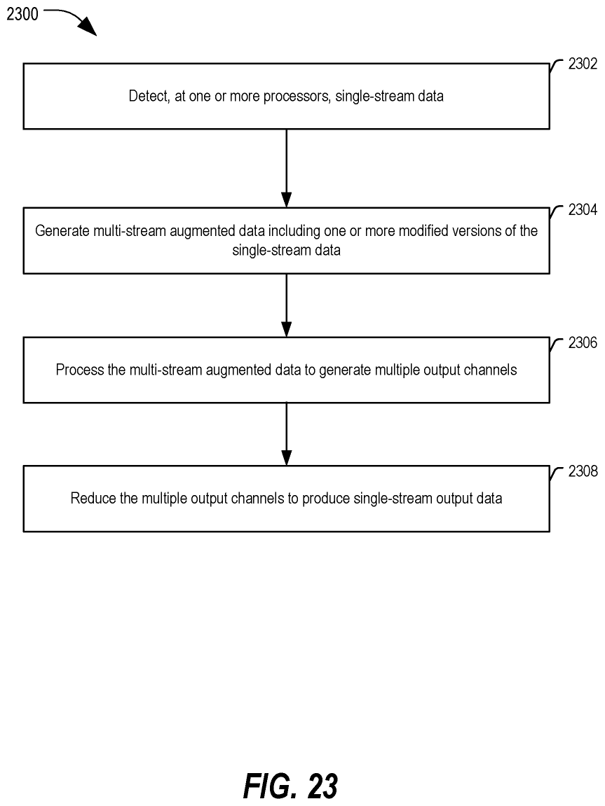

Referring to FIG. 23, a particular implementation of a method 2300 of multi-stream processing of single-stream data is shown. In a particular aspect, one or more operations of the method 2300 are performed by at least one of the multi-stream augmented data generator 160, the multi-stream data processing unit 164, the channel reducer 168, the processor(s) 104, the device 102, the device 152, the system 100 of FIG. 1, or a combination thereof.

The method 2300 includes, at block 2302, detecting, at one or more processors, single-stream data. For example, the processor(s) 104 can detect receipt of the single-stream data 120 via the input interface 106, via the modem 110, or both.

The method 2300 includes, at block 2304, generating multi-stream augmented data including one or more modified versions of the single-stream data. For example, the multi-stream augmented data generator 160 generates the multi-stream augmented data 162 that includes one or more modified versions of the single-stream data 120, such as by applying the first operation(s) 202.

The method 2300 includes, at block 2306, processing the multi-stream augmented data to generate multiple output channels. For example, the multi-stream data processing unit 164 processes the multi-stream augmented data 162 at the network 170 to generate the multiple output channels 166.

The method 2300 includes, at block 2308, reducing the multiple output channels to produce single-stream output data. For example, the channel reducer 168 processes the output channels 166 to generate the single-stream output data 140.

In some implementations, the method 2300 includes performing one or more first operations on the single-stream data to generate the one or more modified versions of the single-stream data. For example, the multi-stream augmented data generator 160 performs the one or more first operations 202, which may include a frequency-domain phase shift 304, a frequency-domain group phase shift 504, a time-domain shift 904, applying a gain, such as described with reference to the gain adjustment 704, or a combination thereof.

According to a particular aspect, reducing the multiple output channels includes performing one or more second operations on at least one of the multiple output channels to generate adjusted multi-channel output data, where the one or more second operations correspond to inverse operations of the one or more first operations. For example, the channel reducer 168 can perform the one or more second operations 204, which may include an inverse frequency-domain phase shift 404, an inverse frequency-domain group phase shift 604, an inverse time-domain shift 1004, an inverse gain adjustment 804, or a combination thereof. Reducing the multiple output channels also includes combining channels of the adjusted multi-channel output data to generate the single-stream output data, such as described with reference to the combination operation 206.

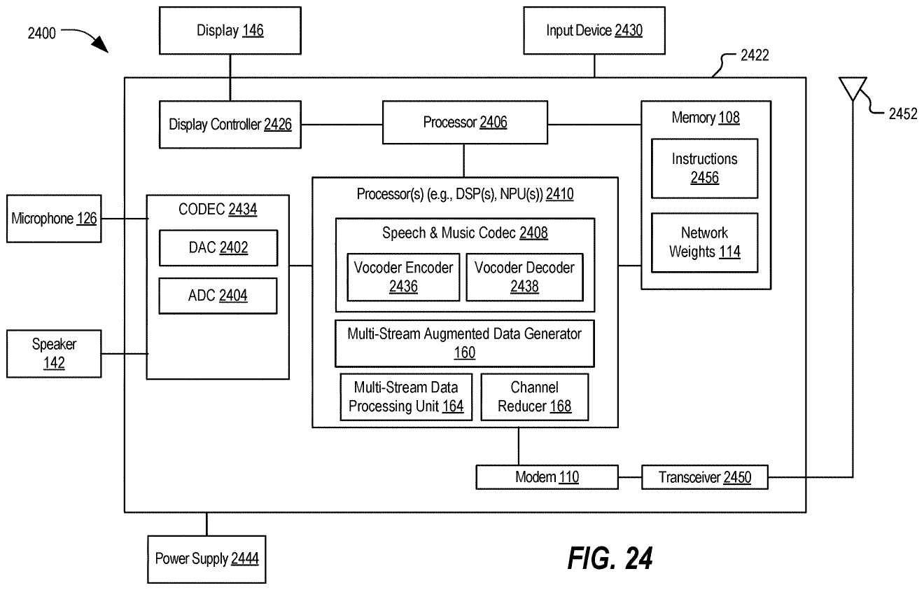

The method 2300 of FIG. 23 may be implemented by a field-programmable gate array (FPGA) device, an application-specific integrated circuit (ASIC), a processing unit such as an NPU, a CPU, a DSP, a controller, another hardware device, firmware device, or any combination thereof. As an example, the method 2300 of FIG. 23 may be performed by a processor that executes instructions, such as described with reference to FIG. 24.

Referring to FIG. 24, a block diagram of a particular illustrative implementation of a device is depicted and generally designated 2400. In various implementations, the device 2400 may have more or fewer components than illustrated in FIG. 24. In an illustrative implementation, the device 2400 may correspond to the device 102 or the device 152. In an illustrative implementation, the device 2400 may perform one or more operations described with reference to FIGS. 1-23.

In a particular implementation, the device 2400 includes a processor 2406 (e.g., a central processing unit (CPU)). The device 2400 may include one or more additional processors 2410 (e.g., one or more NPUs, one or more DSPs, or a combination thereof). In a particular aspect, the processor(s) 104 of FIG. 1 correspond to the processor 2406, the processors 2410, or a combination thereof. The processors 2410 may include a speech and music coder-decoder (CODEC) 2408 that includes a voice coder (“vocoder”) encoder 2436, a vocoder decoder 2438, the multi-stream augmented data generator 160, the multi-stream data processing unit 164, the channel reducer 168, or a combination thereof.

The device 2400 may include the memory 108 and a CODEC 2434. The memory 108 may include instructions 2456 that are executable by the one or more additional processors 2410 (or the processor 2406) to implement the functionality described with reference to the multi-stream augmented data generator 160, the multi-stream data processing unit 164, the channel reducer 168, or a combination thereof. In the example illustrated in FIG. 24, the memory 108 also includes the network weights 114.

In FIG. 24, the device 2400 includes the modem 110 coupled, via a transceiver 2450, to an antenna 2452. The modem 110, the transceiver 2450, and the antenna 2452 may be operable to receive an input media stream, to transmit an output media stream, or a combination thereof.

The device 2400 may include the display device 146 coupled to a display controller 2426. The speaker 142 and the microphone 126 may be coupled to the CODEC 2434. The CODEC 2434 may include a digital-to-analog converter (DAC) 2402, an analog-to-digital converter (ADC) 2404, or both. In a particular implementation, the CODEC 2434 may receive analog signals from the microphone 126, convert the analog signals to digital signals using the analog-to-digital converter 2404, and provide the digital signals to the speech and music codec 2408. The speech and music codec 2408 may process the digital signals, and the digital signals may further be processed by the multi-stream augmented data generator 160, the multi-stream data processing unit 164, the channel reducer 168, or a combination thereof. In a particular implementation, the speech and music codec 2408 may provide digital signals to the CODEC 2434. The CODEC 2434 may convert the digital signals to analog signals using the digital-to-analog converter 2402 and may provide the analog signals to the speaker 142.

In a particular implementation, the device 2400 may be included in a system-in-package or system-on-chip device 2422. In a particular implementation, the memory 108, the processor 2406, the processors 2410, the display controller 2426, the CODEC 2434, and the modem 110 are included in the system-in-package or system-on-chip device 2422. In a particular implementation, an input device 2430 and a power supply 2444 are coupled to the system-in-package or the system-on-chip device 2422. Moreover, in a particular implementation, as illustrated in FIG. 24, the display device 146, the input device 2430, the speaker 142, the microphone 126, the antenna 2452, and the power supply 2444 are external to the system-in-package or the system-on-chip device 2422. In a particular implementation, each of the display device 146, the input device 2430, the speaker 142, the microphone 126, the antenna 2452, and the power supply 2444 may be coupled to a component of the system-in-package or the system-on-chip device 2422, such as an interface (e.g., the input interface 106 or the output interface 112) or a controller.

The device 2400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus means for generating multi-stream augmented data including one or more modified versions of single-stream data. For example, the means for generating multi-stream augmented data can correspond to the processor(s) 104, the multi-stream augmented data generator 160, the multipliers 306, 308, the multipliers 506, 508, the multipliers 706, 708, the shifters 906, 908, the NPU 1104, the processor 2406, the processor(s) 2410, one or more other circuits or components configured to generate multi-stream augmented data including one or more modified versions of single-stream data, or any combination thereof.

In conjunction with the described implementations, the apparatus also means for processing the multi-stream augmented data to generate multiple output channels. For example, the means for processing the multi-stream augmented data to generate multiple output channels can correspond to the processor(s) 104, the multi-stream data processing unit 164, the network 170, the NPU 1104, the processor 2406, the processor(s) 2410, one or more other circuits or components configured to process the multi-stream augmented data to generate multiple output channels, or any combination thereof.

In conjunction with the described implementations, the apparatus also includes means for reducing the multiple output channels to produce single-stream output data. For example, the means for reducing the multiple output channels to produce single-stream output data can correspond to the processor(s) 104, the channel reducer 168, the multipliers 406, 408, the multipliers 606, 608, the multipliers 806, 808, the shifters 1006, 1008, the NPU 1104, the processor 2406, the processor(s) 2410, one or more other circuits or components configured reduce the multiple output channels to produce single-stream output data, or any combination thereof.

In some implementations, a non-transitory computer-readable medium (e.g., a computer-readable storage device, such as the memory 108) stores instructions (e.g., the instructions 2456) that, when executed by one or more processors (e.g., the one or more processors 104, the NPU 1104, the one or more processors 2310 or the processor 2406), cause the one or more processors to detect single-stream data (e.g., the single-stream data 120); generate multi-stream augmented data (e.g., the multi-stream augmented data 162) including one or more modified versions of the single-stream data; process the multi-stream augmented data to generate multiple output channels (e.g., the output channels 166), and reduce the multiple output channels to produce single-stream output data (e.g., the single-stream output data 140).

Particular aspects of the disclosure are described below in a set of interrelated Examples:

According to example 1, a device includes: a memory configured to store instructions; and one or more processors configured to: detect single-stream data; generate multi-stream augmented data that includes one or more modified versions of the single-stream data; process the multi-stream augmented data to generate multiple output channels; and reduce the multiple output channels to produce single-stream output data.

Example 2 includes the device of example 1, wherein the one or more processors are further configured to perform one or more first operations on the single-stream data to generate the one or more modified versions of the single-stream data.

Example 3 includes the device of example 2, wherein, to reduce the multiple output channels, the one or more processors are further configured to: perform one or more second operations on at least one of the multiple output channels to generate adjusted multi-channel output data, the one or more second operations corresponding to inverse operations of the one or more first operations; and perform a combination operation on channels of the adjusted multi-channel output data to generate the single-stream output data.

Example 4 includes the device of example 3, wherein the combination operation includes averaging values of the channels of the adjusted multi-channel output data.

Example 5 includes the device of any of example 2 to example 4, wherein the one or more first operations include a frequency-domain phase shift.

Example 6 includes the device of any of example 2 to example 5, wherein the one or more first operations include a frequency-domain group phase shift.

Example 7 includes the device of any of example 2 to example 6, wherein the one or more first operations include a time-domain shift.

Example 8 includes the device of any of example 2 to example 7, wherein the one or more first operations include applying a gain.

Example 9 includes the device of any of example 1 to example 8, wherein the multi-stream augmented data further includes the single-stream data.

Example 10 includes the device of any of example 1 to example 9, wherein the one or more processors are configured to process the multi-stream augmented data using a recurrent network that processes each stream of the multi-stream augmented data in parallel and that uses the same network weights for each stream of the multi-stream augmented data.

Example 11 includes the device of example 10, wherein the recurrent network is trained using multi-stream augmented training data.

Example 12 includes the device of example 10, wherein the recurrent network is trained using single-stream training data.

Example 13 includes the device of example 10, wherein the one or more processors are configured to: train the recurrent network using multi-stream augmented training data; and use the trained recurrent network to process the multi-stream augmented data during an inference operation.

Example 14 includes the device of example 10, wherein the one or more processors are configured to: train the recurrent network using single-stream training data; and use the trained recurrent network to process the multi-stream augmented data during an inference operation.

Example 15 includes the device of any of example 1 to example 14, wherein the single-stream data includes audio data, and wherein the single-stream output data includes a noise-reduced version of the audio data.

Example 16 includes the device of any of example 1 to example 15, wherein the single-stream data includes single-channel audio data.

Example 17 includes the device of any of example 1 to example 15, wherein the single-stream data includes dual-channel audio data.

Example 18 includes the device of any of example 1 to example 15, wherein the single-stream data includes multi-channel audio data.

Example 19 includes the device of any of example 1 to example 18, further including one or more speakers configured to output audio of the single-stream output data.

Example 20 includes the device of any of example 1 to example 19, further including one or more microphones configured to provide the single-stream data.

Example 21 includes the device of any of example 1 to example 20, further including a modem configured to receive the single-stream data from a second device via wireless transmission.

Example 22 includes the device of example 21, wherein the single-stream data is received in connection with a federated learning network, and wherein the one or more processors are further configured to send the single-stream output data to the second device via the modem.

Example 23 includes the device of any of example 1 to example 22, wherein the one or more processors are included in a neural processing unit (NPU).

Example 24 includes the device of any of example 1 to example 23, wherein the memory and the one or more processors are included in a vehicle.

Example 25 includes the device of any of example 1 to example 23, wherein the memory and the one or more processors are included in an extended reality headset device.

According to example 26, a method includes: detecting, at one or more processors, single-stream data; generating multi-stream augmented data including one or more modified versions of the single-stream data; processing the multi-stream augmented data to generate multiple output channels; and reducing the multiple output channels to produce single-stream output data.

Example 27 includes the method of example 26, further including performing one or more first operations on the single-stream data to generate the one or more modified versions of the single-stream data.

Example 28 includes the method of example 27, wherein reducing the multiple output channels includes: performing one or more second operations on at least one of the multiple output channels to generate adjusted multi-channel output data, the one or more second operations corresponding to inverse operations of the one or more first operations; and combining channels of the adjusted multi-channel output data to generate the single-stream output data.

Example 29 includes the method of example 27 or example 28, wherein the one or more first operations include a frequency-domain phase shift.

Example 30 includes the method of any of example 27 to example 29, wherein the one or more first operations include a frequency-domain group phase shift.

Example 31 includes the method of any of example 27 to example 30, wherein the one or more first operations include a time-domain shift.

Example 32 includes the method of any of example 27 to example 31, wherein the one or more first operations include applying a gain.

Example 33 includes the method of any of example 26 to example 32, wherein the multi-stream augmented data further includes the single-stream data.

Example 34 includes the method of any of example 26 to example 33, wherein the multi-stream augmented data is processed using a recurrent network that processes each stream of the multi-stream augmented data in parallel and that uses the same network weights for each stream of the multi-stream augmented data.

Example 35 includes the method of example 34, wherein the recurrent network is trained using multi-stream augmented training data.

Example 36 includes the method of example 34, wherein the recurrent network is trained using single-stream training data.

Example 37 includes the method of example 34, further including: training the recurrent network using multi-stream augmented training data; and using the trained recurrent network to process the multi-stream augmented data during an inference operation.

Example 38 includes the method of example 34, further including: training the recurrent network using single-stream training data; and using the trained recurrent network to process the multi-stream augmented data during an inference operation.

Example 39 includes the method of any of example 26 to example 39, wherein the single-stream data includes audio data, and wherein the single-stream output data includes a noise-reduced version of the audio data.

Example 40 includes the method of any of example 26 to example 39, wherein the single-stream data includes single-channel audio data.

Example 41 includes the method of any of example 26 to example 39, wherein the single-stream data includes dual-channel audio data.

Example 42 includes the method of any of example 26 to example 39, wherein the single-stream data includes multi-channel audio data.

Example 43 includes the method of any of example 26 to example 42, further including outputting audio of the single-stream output data at one or more speakers.

Example 44 includes the method of any of example 26 to example 43, wherein the single-stream data is provided by one or more microphones.

Example 45 includes the method of any of example 26 to example 43, wherein the single-stream data is received the single-stream data from a second device via wireless transmission.

Example 46 includes the method of example 45, wherein the single-stream data is received in connection with a federated learning network, and further including sending the single-stream output data to the second device via a modem.

Example 47 includes the method of any of example 26 to example 46, performed in a neural processing unit (NPU).

Example 48 includes the method of any of example 26 to example 47, performed at one or more processors included in a vehicle.

Example 49 includes the method of any of example 26 to example 47, performed at one or more processors are included in an extended reality headset device.

According to example 50, a device comprises: a memory configured to store instructions; and a processor configured to execute the instructions to perform the method of any of example 26 to example 49.

According to example 51, a computer-readable medium stores instructions that are executable by a processor to cause the processor to perform the method of any of example 26 to example 49.

According to example 52, an apparatus comprises means for carrying out the method of any of example 26 to example 49.

According to example 53, a non-transitory computer-readable medium stores instructions that, when executed by one or more processors, cause the one or more processors to: detect single-stream data; generate multi-stream augmented data including one or more modified versions of the single-stream data; process the multi-stream augmented data to generate multiple output channels; and reduce the multiple output channels to produce single-stream output data.

According to example 54, an apparatus includes: means for generating multi-stream augmented data including one or more modified versions of single-stream data; means for processing the multi-stream augmented data to generate multiple output channels; and means for reducing the multiple output channels to produce single-stream output data.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A device comprising:
a memory configured to store instructions; and
one or more processors configured to:
detect single-stream data;
generate multi-stream augmented data that includes one or more modified versions of the single-stream data;
process the multi-stream augmented data to generate multiple output channels; and
reduce the multiple output channels to produce single-stream output data.

2. The device of claim 1, wherein the one or more processors are further configured to perform one or more first operations on the single-stream data to generate the one or more modified versions of the single-stream data.

3. The device of claim 2, wherein, to reduce the multiple output channels, the one or more processors are further configured to:
perform one or more second operations on at least one of the multiple output channels to generate adjusted multi-channel output data, the one or more second operations corresponding to inverse operations of the one or more first operations; and
perform a combination operation on channels of the adjusted multi-channel output data to generate the single-stream output data.

4. The device of claim 3, wherein the combination operation includes averaging values of the channels of the adjusted multi-channel output data.

5. The device of claim 2, wherein the one or more first operations include a frequency-domain phase shift.

6. The device of claim 2, wherein the one or more first operations include a frequency-domain group phase shift.

7. The device of claim 2, wherein the one or more first operations include a time-domain shift.

8. The device of claim 2, wherein the one or more first operations include applying a gain.

9. The device of claim 1, wherein the multi-stream augmented data further includes the single-stream data.

10. The device of claim 1, wherein the one or more processors are configured to process the multi-stream augmented data using a recurrent network that processes each stream of the multi-stream augmented data in parallel and that uses the same network weights for each stream of the multi-stream augmented data.

11. (canceled)

12. (canceled)

13. The device of claim 10, wherein the one or more processors are configured to:
train the recurrent network using multi-stream augmented training data; and use the trained recurrent network to process the multi-stream augmented data during an inference operation.

14. (canceled)

15. (canceled)

16. (canceled)

17. The device of claim 1, wherein the single-stream data includes dual-channel audio data.

18. The device of claim 1, wherein the single-stream data includes multi-channel audio data.

19. The device of claim 1, further comprising one or more speakers configured to output audio of the single-stream output data.

20. The device of claim 1, further comprising one or more microphones configured to provide the single-stream data.

21. The device of claim 1, further comprising a modem configured to receive the single-stream data from a second device via wireless transmission.

22. The device of claim 21, wherein the single-stream data is received in connection with a federated learning network, and wherein the one or more processors are further configured to send the single-stream output data to the second device via the modem.

23. The device of claim 1, wherein the one or more processors are included in a neural processing unit (NPU).

24. (canceled)

25. (canceled)

26. A method comprising:
detecting, at one or more processors, single-stream data;
generating multi-stream augmented data including one or more modified versions of the single-stream data;
processing the multi-stream augmented data to generate multiple output channels; and
reducing the multiple output channels to produce single-stream output data.

27. (canceled)

28. (canceled)

29. A non-transitory computer-readable medium storing instructions that, when executed by one or more processors, cause the one or more processors to:
detect single-stream data;
generate multi-stream augmented data including one or more modified versions of the single-stream data;
process the multi-stream augmented data to generate multiple output channels; and
reduce the multiple output channels to produce single-stream output data.

30. (canceled)
